(19) United States
(12) Patent Application Publication
(10) Pub. No.: US 2013/0294576 A1
(43) Pub. Date: Nov. 7, 2013

(54) MONOCHROMATIC X-RAY DEVICES AND METHODS OF USE

(71) Applicants: Anil K. Pradhan, Columbus, OH (US); Yan Yu, Philadelphia, PA (US)

(72) Inventors: Anil K. Pradhan, Columbus, OH (US); Yan Yu, Philadelphia, PA (US)

(21) Appl. No.: 13/880,159

(22) PCT Filed: Oct. 18, 2011
(86) PCT No.: PCT/US11/56694

§ 371 Date: Jul. 22, 2013

Related U.S. Application Data
(60) Provisional application No. 61/393,960, filed on Oct. 18, 2010.

(51) Int. Cl. H01J 35/08; G01N 23/04; G01N 23/02

(52) U.S. Cl. CPC H01J 35/08; G01N 23/02; G01N 23/04
USPC 378/44; 378/124; 378/121; 378/64; 378/62; 378/143

(57) ABSTRACT

Described herein are devices for converting a broadband x-ray beam to at least one substantially monochromatic x-ray beam. The devices may be an adaptor for existing x-ray machines or for use with a standalone machine. The device 20 includes a shielded housing 22 having an inner cavity and a fluorescent target 26, 26′ disposed in the inner cavity 24 wherein the fluorescent target 26, 26′ emits at least one substantially monochromatic x-ray beam when exposed to a broadband x-ray beam. The housing 22 includes a first opening 30 in the housing 22 configured to allow the broadband x-ray beam from an x-ray source to enter the inner cavity 24 and irradiate the fluorescent target 26, 26′ and a second opening 34 in the housing configured to allow the at least one substantially monochromatic x-ray beam emitted by the fluorescent target to exit the housing 22. Also described herein are sources of monochromatic x-rays 60, 84, 112, as well as diagnostic and therapeutic methods of using of monochromatic x-ray beams.

### RELATED APPLICATION

The Present application claims priority to U.S. Ser. No. 61/393,960 filed Oct. 18, 2010, the disclosure of which is hereby incorporated herein by reference in its entirety.

### FIELD OF THE INVENTION

The present invention relates generally to devices and methods for generating and using x-rays, and more specifically to devices and methods for generating and using substantially monochromatic x-rays.

### BACKGROUND OF THE INVENTION

X-ray radiation is used in a number of processes including medical and non-medical diagnostics and therapeutics. Conventional x-ray equipment, such as the equipment used in medical facilities, utilize broadband x-ray radiation (also referred to as bremsstrahlung) having a wide range of energies. Such broadband x-ray equipment is typically used for diagnostic imaging as well as for radiation based therapeutics such as in the treatment of tumors. However, much of the bandwidth of the x-ray energy is not useful for imaging or therapeutics because low-energy x-rays (10-30 keV) do not efficiently penetrate the body to reach the target tissue, and body tissue is nearly transparent to high-energy x-rays (such as from linear accelerators in the MeV range). Since much of the bandwidth of x-ray energy generated by typical broadband x-ray machines is not useful for imaging or therapeutics, subjects imaged or treated with these machines are exposed to a much larger radiation dose than would otherwise be necessary. Exposure to x-rays can increase the risk of a patient having an unwanted side effect, such as the causing tumor. Therefore, it is desirable to develop devices and methods that can decrease a subject exposure to x-rays during diagnostic and therapeutic treatments. Thus, there is a need for cost effective equipment capable of generating x-rays over a narrower useful bandwidth, such as a substantially monochromatic x-ray, to decrease x-ray exposure of subjects.

One type of device for generating substantially monochromatic x-ray energy utilizes fluorescent x-ray emitting sources that, when exposed to bremsstrahlung x-ray energy, fluoresce substantially monochromatic x-ray energy. The efficiencies of these devices to convert bremsstrahlung x-ray energy to monochromatic X-ray energy are typically too low to generate monochromatic X-rays with sufficient intensities to be useful for either diagnostic or therapeutic purposes. To overcome these inefficiency issues, specially designed bremsstrahlung emitting x-ray tubes have been designed for use with fluorescent monochromatic x-ray emitting sources. However, newly designed x-ray tubes typically cannot be used in existing machines without expensive retrofitting or replacement of existing x-ray equipment. Since X-ray equipment is expensive and difficult to retrofit or replace, adaptors are needed that are capable of efficiently generating narrower bandwidth X-ray energy from existing broadband X-ray emitting equipment.

### SUMMARY OF THE INVENTION

Described herein are devices for converting a broadband x-ray beam to at least one substantially monochromatic x-ray beam. The devices may be an adaptor for use with existing x-ray machines and include a shielded housing having an inner cavity and a fluorescent target disposed in the inner cavity. The fluorescent target emits at least one substantially monochromatic x-ray beam when exposed to a broadband x-ray beam. The housing includes a first opening in the housing configured to allow a broadband x-ray beam from an x-ray source to enter the inner cavity and irradiate the fluorescent target and a second opening in the housing configured to allow the at least one substantially monochromatic x-ray beam emitted by the fluorescent target to exit the housing.

Also described herein are sources for at least one substantially monochromatic x-ray beam. In one embodiment, the monochromatic x-ray beam source includes a vacuum chamber, an electron source in the vacuum chamber which radiates focused electrons in a direction to strike an anode and generate a broadband x-ray, and a fluorescent target in the vacuum chamber having a planar surface arranged in the path of the broadband x-ray. The planar surface has an angle relative to the path of the broadband x-ray in the range of about 30 degrees to about 60 degrees. In another embodiment, the monochromatic x-ray beam source includes a vacuum chamber, an electron source in the vacuum chamber which radiates focused electrons in a direction to strike an anode that includes at least a first and a second fluorescent-element. The surface of the anode is planar and has an angle relative to the path of the electrons in the range of about 30 degrees to about 60 degrees.

Also described herein is a method of delivering locally concentrated radiation to a sample. The method includes introducing at least one high Z element to the tissue and simultaneously irradiating the high Z element in the sample with at least a first substantially monochromatic x-ray beam and a second substantially monochromatic x-ray beam. The first substantially monochromatic x-ray beam has an energy sufficient to ionize the k-shell of the high Z element thereby allowing an electron from an outer shell to collapse to the k-shell and release an x-ray photon, and the second substantially monochromatic x-ray beam has an energy sufficient to elevate an electron from the k-shell into a vacancy in an outer shell thereby reionizing the k-shell and sustaining the local x-ray emission cycle. This embodiment is particularly useful with radiation therapy using high Z element containing radiosensitizing agents to kill malignant cells.

Also described herein is a diagnostic method that includes irradiating a sample with a first substantially monochromatic x-ray beam and a second monochromatic x-ray beam and detecting the first substantially monochromatic x-ray beam and the second monochromatic x-ray beam that pass through the sample.

### BRIEF DESCRIPTION OF THE DRAWINGS

FIG. 1A illustrates the ionization of the k-shell of an atom.

FIG. 1B illustrates the transition of a higher orbital electron to the k-shell vacancy and the resulting potential emissions.

FIG. 2A is representative graph of the monochromatic x-ray emitted from a Zirconium fluorescent target.

FIG. 2B is a representative graph of the data from FIG. 2A with the background subtracted.

FIG. 3A illustrates the triggering ionization of the k-shell of an atom.

FIG. 3B illustrates the transition of a higher orbital electron to the k-shell vacancy and the resulting potential emissions.

FIG. 3C illustrates the resonant absorption of a pumping x-ray elevating a k-shell electron to an L-shell vacancy.

FIG. 4 illustrates an embodiment of the process for converting a broadband x-ray to a substantially monochromatic x-ray in accordance with embodiments of the invention.

FIG. 5A is a perspective view of an exemplary adaptor for converting a broadband x-ray to a substantially monochromatic x-ray in accordance with embodiments of the invention.

FIG. 5B is a cross sectional view of the adaptor of FIG. 5A.

FIG. 5C is a perspective view of an exemplary adaptor for converting a broadband x-ray to a substantially monochromatic x-ray in accordance with embodiments of the invention.

FIG. 6 is a schematic view of a substantially monochromatic x-ray source in accordance with embodiments of the invention.

FIG. 7 is a schematic view of a substantially monochromatic x-ray source according to embodiments of the invention, producing two monochromatic beams of the same of different energies from two high Z targets.

FIG. 8 is a schematic view of a substantially monochromatic x-ray source in accordance with embodiments of the invention.

FIG. 9 is a representative image of x-ray film exposed with a monochromatic x-ray beam in accordance with embodiments of the invention.

FIG. 10A is a representative image of x-ray film exposed with a monochromatic x-ray beam in accordance with embodiments of the invention, showing overlapping copper foils of 25 micron thickness and vials containing nanoparticles of different concentration.

FIG. 10B is a scanned curve from the image of FIG. 10A showing jumps in attenuation by thin layers of copper foil of the monochromatic x-ray beam produced in accordance with embodiments of the invention.

### DETAILED DESCRIPTION OF THE INVENTION

X-ray fluorescence operates on the principle that the illumination of a fluorescent target with x-ray energy results in the emission of x-ray energy having a different energy range. The energy range of the emitted x-ray is determined by the atomic composition of the fluorescent target. Aspects of the invention are directed to x-ray sources and adaptors that utilize x-ray fluorescent principles to generate substantially monochromatic x-rays, as well as methods of utilizing monochromatic x-rays for therapeutic and diagnostic uses.

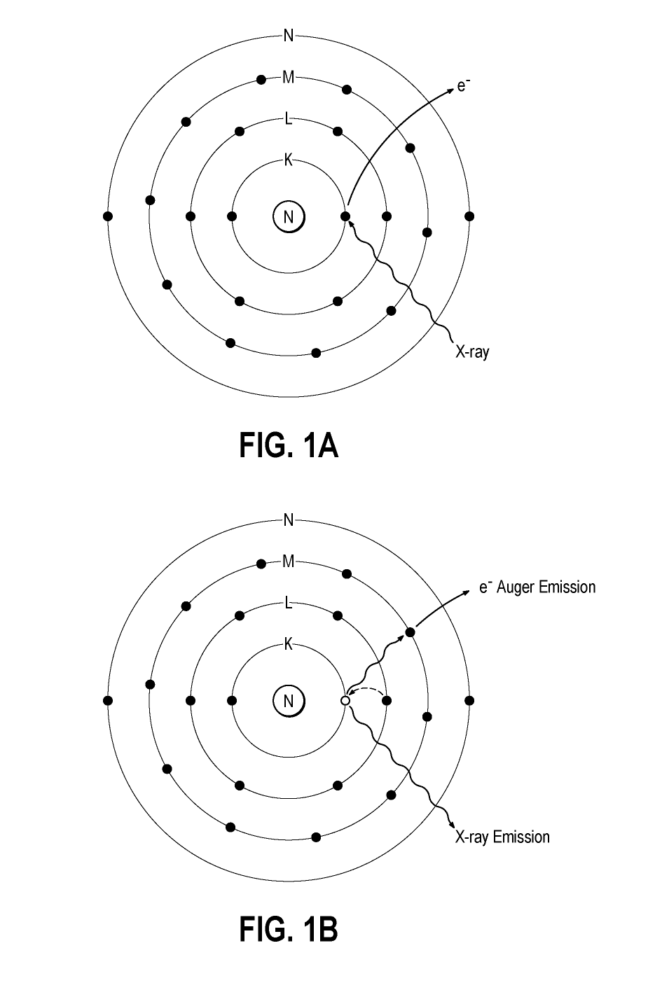

When photons of ionizing x-ray energy (such as bremsstrahlung x-ray energy) strike an atom, the energy may be either reflected or absorbed by the atom. With reference to FIGS. 1A-1B, if x-ray energy is absorbed by that atom and the absorbed energy collides with an electron in an inner orbital (such as a K-shell electron), then the probability exists for the orbital electron to be ejected from the atom as a photoelectron thereby ionizing the atom. The orbital electron will most likely be ejected from the inner orbital if the absorbed x-ray energy is greater than, but relatively close to, the binding energy of the orbital electron. The ejection of the inner orbital electron results in a vacancy in the inner shell of the atom thereby creating an unstable condition in the atom. Electrons from the outer shells (such as the L-shell) will transition to inner shells (K-shell) to stabilize the electron cloud of the atom. The transition of electrons from outer shells to inner shells results in the release of photons of x-ray energy that are characterized by the difference between the binding energies of the electrons in the corresponding shells. The difference in orbital binding energies differs for every element. Accordingly, the bandwidth of x-ray emission that results from the transition of electrons between outer shells to inner shells is distinct for every element. Thus, every element produces a distinctive monochromatic x-ray. One aspect of the invention is directed to x-ray fluorescent devices and methods that include a fluorescent target having one or more elements that emit x-rays over a desired bandwidth, such as substantially monochromatic or substantially dichromatic bandwidths, when irradiated with an x-ray. While the term substantially monochromatic and at least one substantially monochromatic x-ray are primarily used in the description of specific embodiments described herein, it is understood that the inventive devices, compositions, and processes are not so limited and could include emit multiple substantially monochromatic x-ray beams dependent on the elemental composition of the fluorescent material.

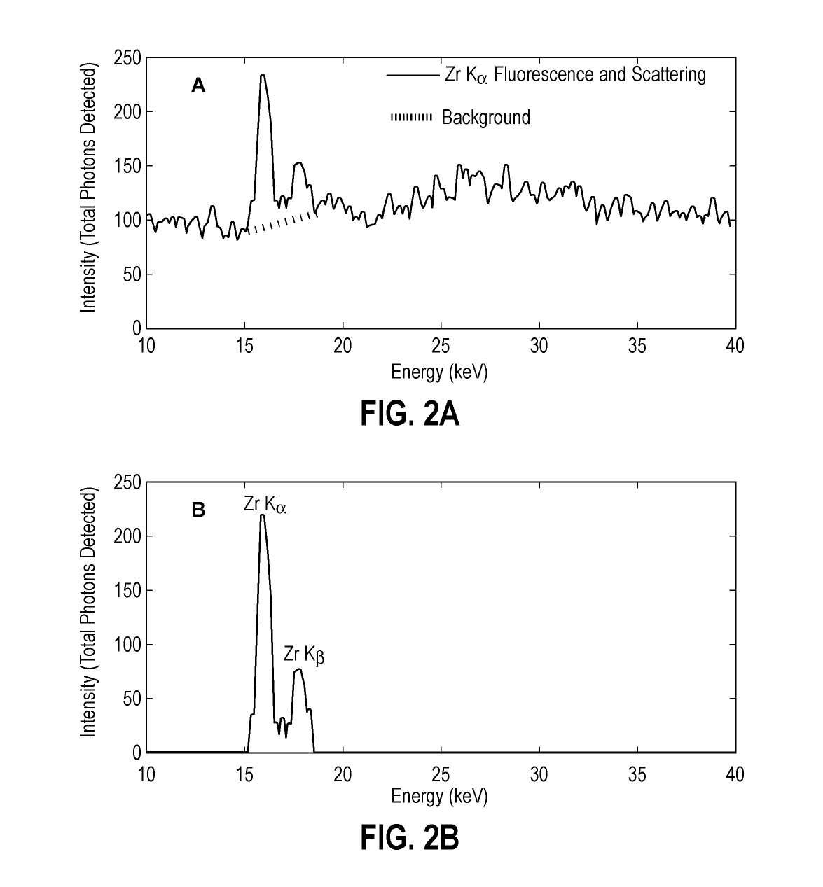

The most well known monochromatic X-rays correspond to the Kα line, which is the strongest atomic transition in terms of probability or cross section relative to other higher transitions. The Kα line corresponds to the x-rays that result from the transition of an electron from the L shell to the K shell. Thus, Kα x-rays are proposed as the primary agents for the substantially monochromatic diagnostic and therapeutic process described herein. However, higher energy transitions such as Kβ, Kγ, etc. are also relevant to devices, compositions, and methods described herein. For example, as illustrated in FIGS. 2A and 2B, a plate of zirconium irradiated with bremsstrahlung x-ray energy fluoresces with characteristic Kα and Kβ lines. Those of ordinary skill will appreciate that k lines, i.e., Kα line, Kβ line, etc., refers to a narrow bandwidth of x-ray energy whose width or range is characterized by the atom from which the line originates.

With reference back to FIG. 1B, in some instances, a monochromatic x-ray emitted by the transition of an electron from an outer shell to an inner shell is absorbed by a second electron in an outer shell of the atom causing an Auger emission, i.e., the second electron is ejected from orbit from the atom's electron cloud. The probabilities of Auger emissions increase with atomic number Z. The ejection of the second electron further destabilizes the atom and will result in the transition of another outer orbital electron down to fill the new vacancy left by the ejected second electron thereby causing the emission of another monochromatic x-ray. This additional x-ray emission could also be absorbed by an outer electron causing a further Auger emission. Owing to the fact that higher electronic shells have increasingly more electrons, Auger emission involving higher shells are more numerous and are also referred to as Coster-Kronig or Super-Coster-Kronig transitions.

Auger emissions can be especially beneficial when the target atom is a high Z atom, i.e., an atom with a atomic weight of greater than 26, and the high Z atom is loaded into a tissue, as discussed in greater detail below. The ejected Auger emission electron is capable of travelling about 1 to about 100 μm into the surrounding tissue before losing its energy, mostly localized to within about 10 μm. The damage to cells along the ejected electron's path is great because the density of the energy transfer per micrometer is much higher than regular electrons or x-ray photons. This deposition of energy is similar to how protons deposit energy to a target tissue at the end of their ranges. At specific resonant energies, the very low energy Auger electrons may also attach themselves to the DNA of malignant cells causing single and double-strand breakups. Aspects of the present invention applying these principles will provide a low cost devices and methods having a similar effectiveness as proton beam devices which cost in the hundreds of millions of dollars.

Avoiding auger emission from common elements present in the body having an atomic number up to iron (Z=26) could be advantageous for limiting radiation dose in most tissues of the body. Thus, one embodiment of the invention uses monochromatic x-ray beams having a characteristic energy that limits Auger emissions from these common elements, i.e., having an atomic number of up to 26. It has also been observed that some diseased tissues, such as cancerous tissues, have relatively high levels of calcium (Z=20) and iron (Z=26) compared to surrounding tissues. Thus, in some embodiments, it may be advantageous to target these tissue with monochromatic irradiation that will target atoms having an atomic number of at least 20, or at least 26.

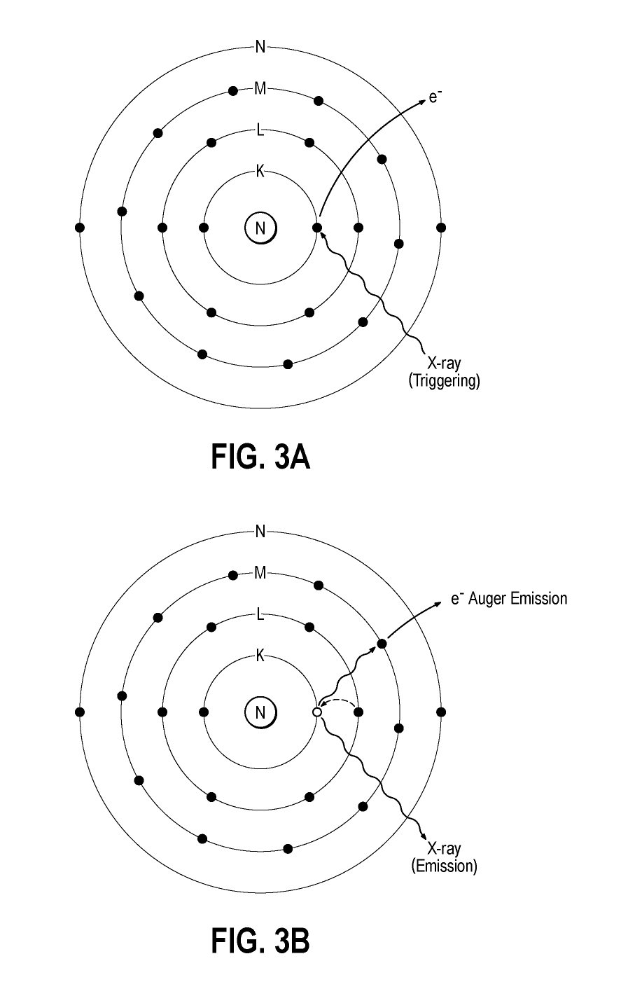

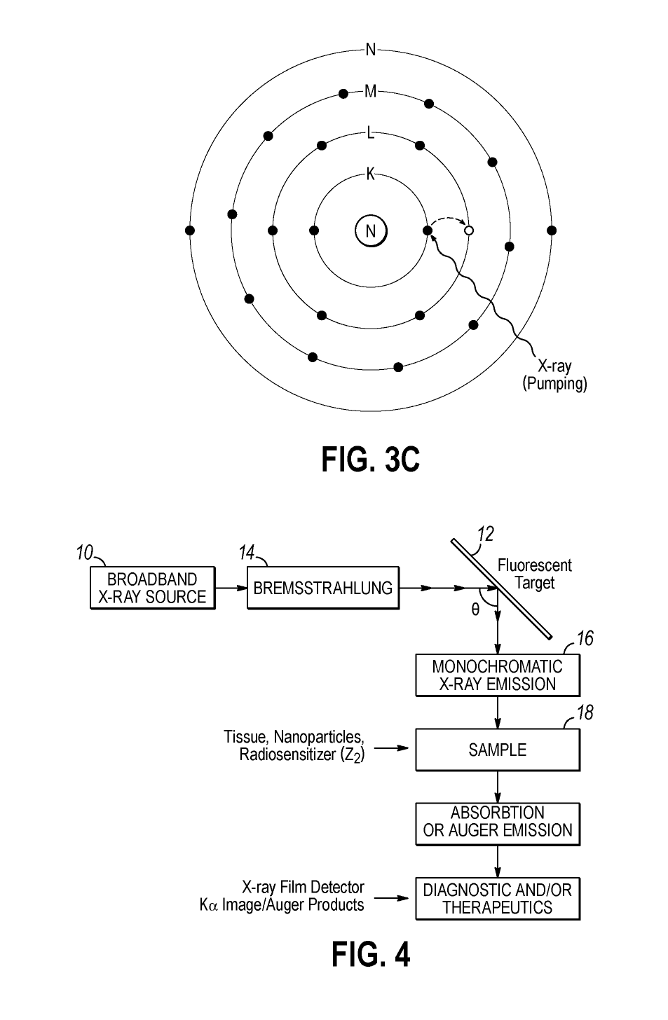

With reference to FIGS. 3A-3C, another aspect of the invention is directed to the novel concept of using tuned substantially monochromatic x-ray beams to generate an Auger emission engine for localized energy deposition near a high Z element in a sample. The Auger engine utilizes a first substantially monochromatic x-ray beam functioning as a triggering x-ray photon and a second substantially monochromatic x-ray beam functioning as a pumping x-ray photon that are tuned to maintain the Auger emission from a fluorescent high Z element loaded into a sample. The triggering x-ray photon has an energy sufficient to ionize high Z element atoms by ejecting an inner orbital electron, such as a k-shell electron, from the atom (FIG. 3A). A monochromatic x-ray is released as an outer shell electron, such as an L-shell electron, collapses down to fill the vacancy left by the ejected inner shell electron (FIG. 3B). This process is referred to as a resonant emission. The pumping x-ray photon reverses the resonant emission to achieve resonant absorption. Resonant absorption is achieved when the energy of the pumping x-ray photon is absorbed by an inner shell electron, such as a k-shell electron, and the absorbed energy is sufficient to elevate the electron to fill the vacancy in the outer shell, such a vacancy in the L-shell, caused by the earlier resonant emission (FIG. 3C). The elevation of the inner shell electron leaves another vacancy in the inner shell which will result in another x-ray being released as an outer shell electron collapses down to fill the vacancy left by the elevated electron (FIG. 3B). This cycle may be repeated so long as the atom is exposed to pumping x-ray photons and the outer shells of the atom have electrons that can be ejected. Thus, atoms of high Z elements are preferred for the localized deposition of energy to a sample. The triggering x-ray photon has a higher energy relative to the pumping x-ray photon. Due to the speed with which electrons from higher shells collapse to fill the vacancies in inner shells, the triggering x-ray photon and the pumping x-ray are advantageously administered simultaneously to sustain the Auger emission engine.

FIG. 4 illustrates the process for generating at least one substantially monochromatic x-ray beam based on the principles described above. A conventional broadband x-ray source 10, such as a conventional x-ray machine utilized in medical or dental settings, irradiates a fluorescent target 12 with a broadband x-ray beam such as an x-ray bremsstrahlung beam 14. The fluorescent target 12 includes atoms of elements that selected to emit at least one substantially monochromatic x-ray beam. Preferable elements Z1 are heavy elements, i.e., elements with a high atomic number Z, react with the x-ray bremsstrahlung beam 14 to emit a substantially monochromatic x-ray with increasing efficiency as the atomic number Z of the atoms in the fluorescent target increases. The at least one substantially monochromatic x-ray beam 16 emitted from the fluorescent target irradiates a sample 18 (e.g. body tissue) that includes elements having atomic number Z2, with the criterion that the atomic number of the Z2 elements is less than the atomic number of the Z1 element so that the substantially monochromatic x-ray beam 16 will have sufficient energy to ionize the K shell of the Z2 elements in the sample 18. Z2 elements in the sample 18 may be high Z elements or may be other elements naturally found in the tissue sample.

Some aspects of the invention are directed to methods employing two or more substantially monochromatic x-ray beams. For these methods, multiple substantially monochromatic x-ray beams may generated in a number of ways. For example, the fluorescent target 24 of FIG. 4 may include two or more different elements, such as two or more high Z elements, each selected to emit a substantially monochromatic x-ray beam as the target is irradiated by the broadband x-ray source 10. In another embodiment, two or more substantially monochromatic x-ray beam emitting fluorescent targets, such individually described above with reference to FIG. 4, could be arranged to simultaneously irradiate the sample. Other methods of generating more than one substantially monochromatic x-ray beam may be employed in these methods as well.

High Z elements are used in some embodiments of the present invention because elements fluoresce in response to x-rays with efficiencies that increases with the atomic number (Z). Nanoparticles of high Z elements, such as gold (Z=79), platinum (Z=78), and other generally non-reactive and non-toxic elements are ideal for use in biological tissues. High Z elements can be associated with at least one of medical device, a contrast agent, a nanoparticle, a chemotherapy agent, a radiotherapy agent, and combinations thereof. An exemplary medical device is a vascular stent. In addition, radiosensitizing molecular agents widely used in imaging, such as bromodeoxyuridine (BUdR) or iodeoxyuridine (IUdR) are also useful since they contain high Z elements Br (Z=35) and I (Z=53) respectively. In addition to the high Z elements listed above, other preferable high Z elements include Zr, Cu, Ag, Mo, Kr, U, Gd, W and combinations thereof. While high Z elements may be preferred, other elements may be useful with certain embodiments of the invention. The useful elements, such as high Z elements, can be used alone or in combination, such as in a nanoparticle, or can be targeted to a specific tissue such through association with an antibody or receptor ligand that targets the tissue of interest, such as a benign tumor, a malignant tumor, a lesion, an infectious agent, a plaque, a cyst, a blood vessel and combinations thereof. For example, nanoparticles of high Z elements can be designed and coated with antigens so as to target antibodies in the tissues of interest such cancerous tumors. The nanostructures may assume various shapes such as nanospheres, nanorods, nanotubes etc. Upon x-ray irradiation, a nano-plasma is created resulting in Auger cascades that would kill cancerous cells to which the nanostructures are attached.

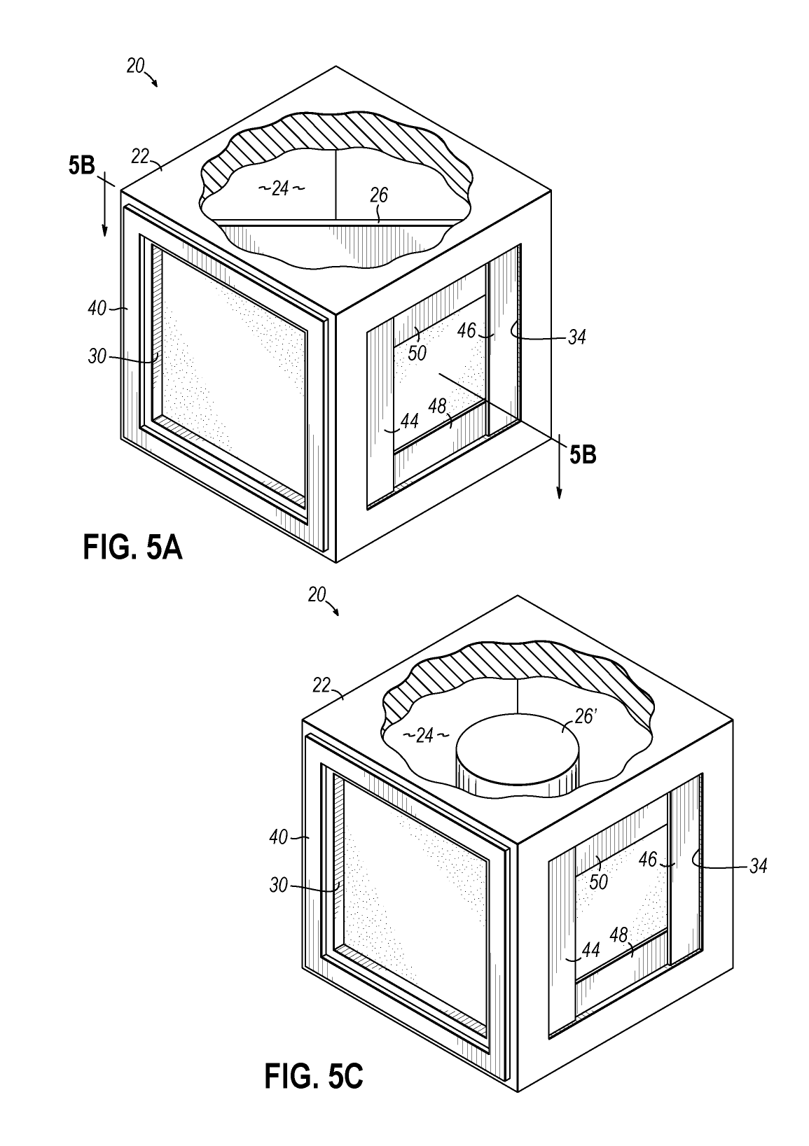

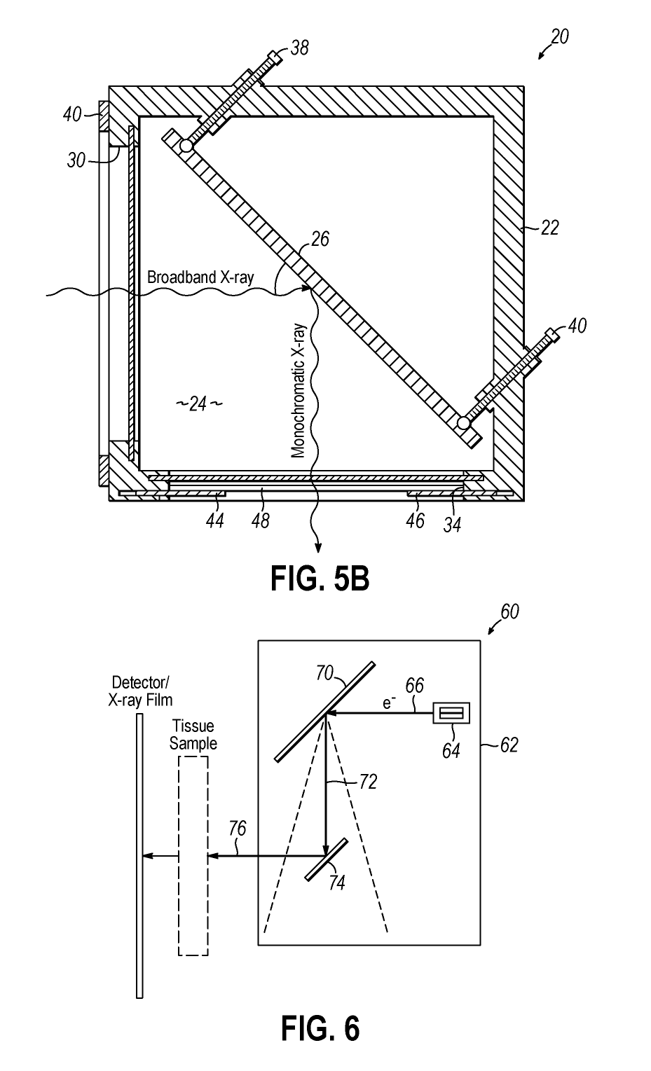

With reference to FIGS. 5A, 5B, and 5C, one aspect of the invention is directed to a device 20 for converting a broadband x-ray beam to at least one substantially monochromatic x-ray beam. A particularly advantageous use of the device 20 is as an adaptor for an existing broadband x-ray machine 10 (of FIG. 4), such as typically found in a medical or dental facility. When used as an adaptor/convertor, the device 20 converts the regular broadband x-ray beam from the existing machine into at least one substantially monochromatic x-ray beam without having to replace or significantly retrofit the machine. For example, the device 20 can be used with single exposure broadband x-ray machines or even scanning x-ray machines such as CT scan machines. The device 20 can also be a part of a simple stand alone monochromatic device that includes a broadband x-ray source configured relative to the fluorescent target as shown in FIG. 4.

The device 20 includes a shielded housing 22 having an inner cavity 24 and a fluorescent target 26, 26′ disposed in the inner cavity 24. The housing 22 also has a first opening 30 configured to allow a broadband x-ray beam from an x-ray source to enter the inner cavity 24 and irradiate the fluorescent target 26, 26′. The housing 22 also has a second opening 34 configured to allow a substantially monochromatic x-ray beam emitted by the fluorescent target 26, 26′ to exit the housing 22. The first and second openings may optionally be covered with a glass 28 and 29 that will not interfere with the broadband or monochromatic energy passing through the housing.

The fluorescent target 26, 26′ is disposed on the inner cavity 24 as such an angle relative to the first and second openings 30, 34 such that upon irradiation by a broadband x-ray entering the first opening 30, the fluorescent substantially monochromatic x-ray beam can exit the housing 22 through the second opening 34. The fluorescent target 26 is angled relative to the path of the broadband beam so as to limit contamination of the substantially monochromatic beam with the broadband beam. The angle of the fluorescent target 26 relative to the path of the broadband x-ray beam is may vary between about 30 degrees to about 60 degrees. Advantageously, the angle is between about 40 degrees and about 50 degrees. Most advantageously, the angle is about 45 degrees. The angle of the fluorescent target relative to the broadband x-ray beam, or in the alternative, relative to the first and/or second openings, may be adjustable, such as through the use of one or more set screws 38, 40 (FIG. 5B). Those of ordinary skill will appreciate that the angle may be adjusted with other mechanisms, such as with small motors that control the angle of the target 26.

The fluorescent target 26 may include any element of the Periodic Table. The elements used in the fluorescent target 26 are selected to emit characteristic substantially monochromatic x-ray beams having a desired bandwidth. Advantageously, the fluorescent target 26 utilizes a single element, such as a high Z element, that fluoresces at the desired bandwidth. The fluorescent target 26 may include two or more elements, such as two or more high Z elements, that emit two or more substantially monochromatic x-ray beams, with each substantially monochromatic x-ray beam emanating from the respective element. In one embodiment, the fluorescent target 26 includes at least two high Z elements that are selected to function in the resonant absorption/resonant emission method described above. In another embodiment, the fluorescent target 26 includes at least two elements that are selected to provide improved imaging. In one embodiment, the fluorescent target 26 is substantially planar. However, non-planar geometries are readily constructed. For example, as shown in FIG. 5C, a sealed container filled with gaseous fluorescent elements, such as gaseous high Z elements, can be used as the fluorescent target, and may take the shape of a cylinder 26′, sphere or other similar suitable structure. For the Typical sealed containers will have a high heat capacity while being relatively transparent to x-ray photons. Similar sealed containers are currently in use in electron beam ion trap devices.

The housing 22 may further include a structure or structures configured for reversibly couple the housing to an x-ray machine so as to maintain a fixed geometry between the fluorescent target 26, 26′ and the x-ray machine. As mentioned above, one use for the device 22 is as an adaptor or converter for use with existing broadband x-ray equipment such as the broadband x-ray source 10 in FIG. 4. The existing x-ray equipment may be modified to include a mechanism for coupling the housing 22 so that a broadband x-ray beam exiting the x-ray machine may enter the first opening 30 of the housing 22. For example, and the housing 22 may have a magnet 40 that is complementary to a magnetic structure on the x-ray machine (not shown) and that allows the housing 22 to easily be attached or removed from the x-ray machine as needed (FIGS. 5A and 5B). The x-ray machine and housing 22 may alternatively include complementary mounting brackets (not shown) or other such structures as are known in the art for reversibly coupling complementary components together.

The device 20 may also include a beam-shaping apparatus configured to shape the narrower bandwidth x-ray beam. The beam-shaping apparatus is at least one of a pair of jaws 44, 46, 48, and 50 forming a rectangular beam, a set of iris shutters forming a polygonal shaped beam, and a set of leaves forming an irregularly shaped beam. Beam shaping structures, also known in the art as collimators, may be employed in various forms and may be manually or electronically controlled. In one embodiment, data collected during use of the device 20 is used to control the shape of the beam so that the x-ray dose may be given only to a precisely targeted space that may have some slight movement.

With reference to FIG. 6, one aspect of the invention is directed to a source for a substantially monochromatic x-ray beam such as in the form of a monochromatic x-ray tube 60. The monochromatic x-ray tube 60 includes a vacuum chamber 62 with an electron source 64 located therein. The electron source 64 radiates focused electrons 66 in a direction to strike an anode 70 and generate a broadband x-ray beam 72. The electron source 64 and the anode 70 employ conventional circuitry (not shown) generally known and used in conventional x-ray tubes. A fluorescent target 74 is arranged in the path of the broadband x-ray beam 72 generated by the anode 70 in the vacuum chamber 62. The surface of the fluorescent target 74 is planar so as to reduce contamination of the substantially monochromatic x-ray beam 76 with the broadband x-ray beam 72 from the anode 70. The planar surface has an angle relative to the path of the broadband x-ray in the range of about 30 degrees to about 60 degrees. Advantageously, the angle is between about 40 degrees and about 50 degrees. Most advantageously, the angle is about 45 degrees.

Similar to the fluorescent target 26 of the device 22 illustrated in FIGS. 5A and 5B, fluorescent target 74 of the monochromatic x-ray tube may include any element of the Periodic Table. The elements used in the fluorescent target 74 are selected to emit characteristic substantially monochromatic x-ray beams having a desired bandwidth. Advantageously, the fluorescent target 26 utilizes a single element, such as a high Z element, that fluoresces at the desired bandwidth. In the alternative, the fluorescent target 74 may include two or more elements, such as two or more high Z elements, that emit two or more substantially monochromatic x-ray beams 76, with each substantially monochromatic x-ray beam 76 emanating from the respective element. In one embodiment, the fluorescent target 74 includes at least two high Z elements that are selected to function in the resonant absorption/resonant emission method described above. In another embodiment, the fluorescent target 74 includes at least two elements that are selected to provide improved imaging.

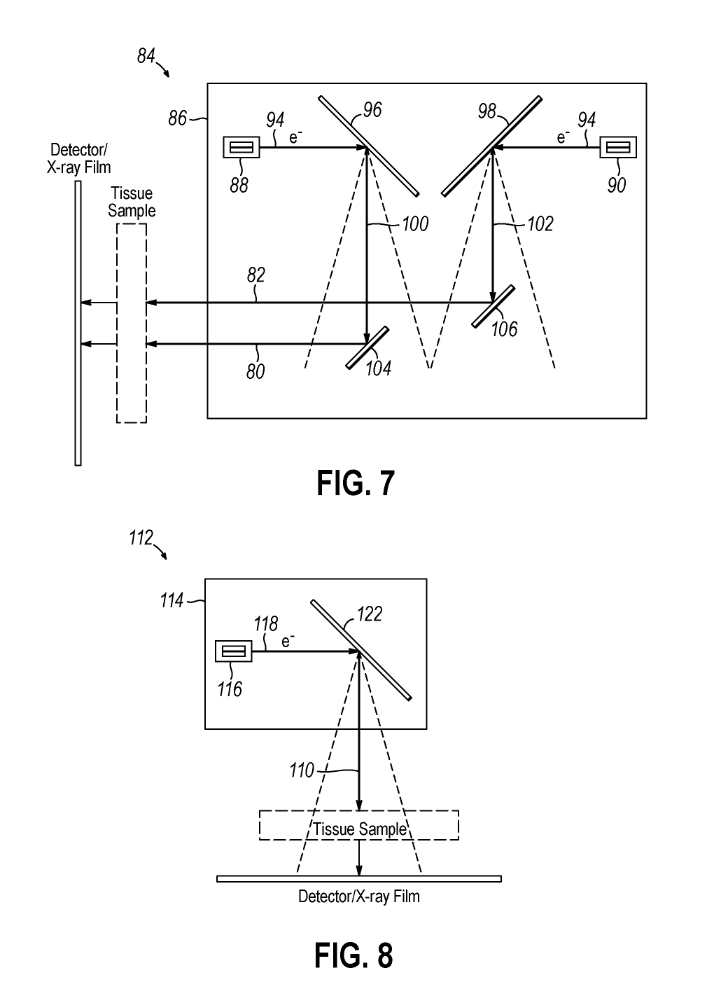

With reference to FIG. 7, one aspect of the invention is directed to a source for a first substantially monochromatic x-ray beam 80 and a second substantially monochromatic x-ray beam 82 such as in the form of a monochromatic x-ray tube 84. The monochromatic x-ray tube 84 includes a vacuum chamber 86 with a first electron source 88 and a second electron source 90 located therein. The first electron source 88 radiates focused electrons 94 in a direction to strike a first anode 96 and generate a first broadband x-ray beam 100. Likewise, the second electron source 90 radiates focused electrons 94 in a direction to strike a second anode 98 and generate a second broadband x-ray beam 102. The first and second electron sources 88, 90 and the first and second anodes 96, 98 employ conventional circuitry (not shown) generally known and used in conventional x-ray tubes. A first fluorescent target 104 is arranged in the path of the first broadband x-ray beam 100 and a second fluorescent target 106 is arranged in the path of the second broadband x-ray beam 102. The surfaces of the first and second fluorescent targets 104, 106 are planar so as to reduce contamination of the first and second substantially monochromatic x-ray beams 80, 82 with the first or the second broadband x-ray beams 100, 102. The planar surfaces of the first and second fluorescent targets 104, 106 have an angle relative to the path of the respective broadband x-ray beams 100, 102 in the range of about 30 degrees to about 60 degrees. Advantageously, the angle is between about 40 degrees and about 50 degrees. Most advantageously, the angle is about 45 degrees. The angles may be adjusted depending on the shapes and sizes of the fluorescent targets so as to maximize the harvesting of monochromatic photon flux.

With reference to FIG. 8, one aspect of the invention is directed to a source for a substantially monochromatic x-ray beam 110 such as in the form of a monochromatic x-ray tube 112. The monochromatic x-ray tube 112 includes a vacuum chamber 114 with an electron source 116 located therein. The electron source 116 radiates focused electrons 118 in a direction to strike an anode 122 that includes at least one element selected to irradiate a substantially monochromatic x-ray beam. The electron source 116 and the anode 122 employ conventional circuitry (not shown) generally known and used in conventional x-ray tubes. The substantially monochromatic x-ray beam irradiating from the anode 122 is collected at about a 90 degree angle or oblique angle relative to the electron beam so as to decrease contamination of the substantially monochromatic x-ray beam by inevitable broadband x-rays produced in the anode. The surface of the anode 122 is planar and has an angle relative to the path of the electron beam in the range of about 30 degrees to about 60 degrees. Advantageously, the angle is between about 40 degrees and about 50 degrees. Most advantageously, the angle is about 45 degrees.

Sometimes even with selection of the most preferable angle, it is not possible to eliminate substantial contamination by broadband bremsstrahlung radiation, and it is therefore desirable to use filters to remove the unwanted components of the spectrum. Such filters can be fabricated using the same high Z element as the anode 122. This has the advantage that the substantially monochromatic radiation will pass through the filter without significant absorption, while radiation at other energies is absorbed. When the target 122 includes more than high Z element, such filter can be fabricated using the same high Z elements as in target 122, or only one of these elements.

The devices and methods described herein are useful for therapeutic and diagnostic purposes. Moreover, the devices and methods may be used in an integrated system that both provides an image of the subject and administers a therapeutic x-ray dose to the subject based on data collected from the image. In addition to medical uses, the devices and methods may be useful in other areas wherein x-rays are employed such as with monochromatic x-ray crystallography, non-destructive testing of materials, security scanning of packages and cargo, screening of materials for contaminates, and evaluating the structural integrity of objects such as metal fatigue testing.

### EXAMPLE 1

A fluorescent target comprised of a plate of either copper or zirconium was irradiated with a broadband x-ray beam from a Oldelft Simulix-HP/20T x-ray simulator. The broadband beam had an energy of 80 keV. The fluorescent plate was set at an angle of 45 degrees relative to the broadband x-ray beam. X-ray film, both ultra sensitive and conventional, were placed in a lead encased housing and situated in the path of the monochromatic x-ray beam emitted from the fluorescent target. The film was situated at a 45 degree angle relative to the fluorescent target.

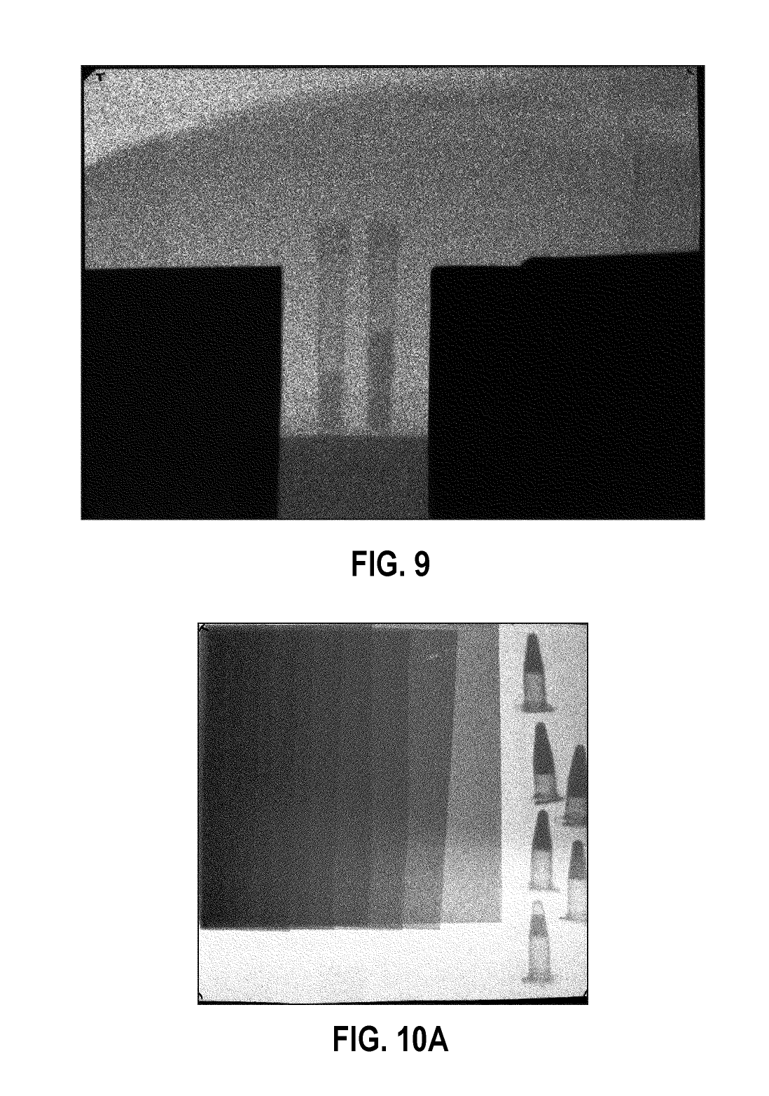

As seen in FIG. 9, the results using copper K-alpha radiation. The image shows two plastic tubes filled with gold nanoparticles at different concentrations. The blackened images on either side are copper plates of about 1 mm thickness that block out the monochromatic x-ray beam fluorescing from copper entirely. If the radiation had not been monochromatic, and had contained high energy X-rays up to 80 keV (operational voltage of the Simulator) then high energy X-rays would have penetrated the copper plates and exposed the ultra-sensitive X-ray film.

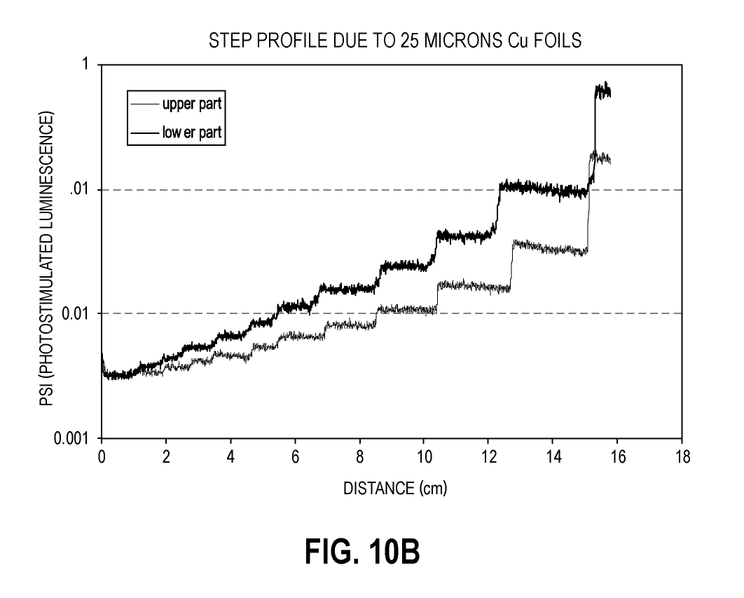

FIG. 10A, shows an exemplary monochromatic X-ray image from the zirconium (Z1=40) target which fluoresced K-α radiation at 15.77 keV. The image shows very thin (25 microns) overlapping copper foils on the left, and several plastic vials containing bang gel with bromine and gold nanoparticles at different concentrations. FIG. 10B is a scanned curve (from right to left) showing jumps in monochromatic X-ray intensity attenuation of zirconium monochromatic x-ray beam, as it falls off in a step-wise manner at each layer of copper foil. Known attenuation coefficients tabulated by the National Institute of Standards and Technology (NIST; www.nist.gov) can be used to correlate the attenuation coefficients at the monochromatic K-alpha X-ray energy.

### EXAMPLE 2

A standard electron gun of up to 70 keV energy is vacuum-fitted with a gadolinium-tungsten anode. The monochromatic X-ray photons (isotropically emitted) are harvested at a 90 degree or an oblique angle from the gadolinium-tungsten target in order to obtain a pristine narrowband photon beam. The relative thickness of gadolinium vs. tungsten is optimized using a Monte Carlo simulation. The goal of the Monte Carlo optimization is to achieve just enough tungsten 2p→1s photons (at 58-59 keV depending on fine structure splitting) to act as the trigger photon, which initiates the 1s photoionization in gadolinium (at 50.2 keV) in vivo, i.e., in the sample. Gadolinium is known to have enhanced uptake in tumors such as breast cancer. Another goal of such Monte Carlo optimization is to obtain sufficient flux of gadolinium characteristic photons to sustain the Auger emission engine in vivo. A recent Monte Carlo simulation run showed that the ratio (by number) of all fluorescent photons (average energy 45.6 keV) to incident electrons impinging on a gadolinium anode in the 90 degree geometry would be 0.00034% at 55 keV incident electron energy for a gadolinium target of 1 mm radius and 5 mm height, irradiating an area placed 1 cm away from the target. Using the nominal incident electron current of 6 mA, this would translate to 55.7 cGy/min of pristine fluorescent photons. This is sufficient for therapeutic purposes.

### EXAMPLE 3

An electron gun of up to 120 keV energy is vacuum-fitted with a gold-depleted uranium anode. The uranium component of the composite anode target will fluoresce predominantly at 94-95 keV, whereas the gold component of the composite target will fluoresce predominantly at 66-67 keV. When this beam is made to impinge on cells, an animal or a human containing gold aggregates such as gold coating on coronary stents, or nanoparticles in specific regions (tumor, or suspicious area of uptake of targeted agents), the higher energy radiation packet at 94-95 keV will first ionize the K shell electron in gold, which requires 80.7 keV. The most likely event that follows is downward transition of an L shell electron in the ionized gold, causing release of 67-68 keV energy. This energy, being released in a high atomic number species with many orbital electrons, will likely lead to Auger electron emissions. The electrons from the Auger emission, will leave the gold atom, and travel about 1 micrometer to about 10 micrometers in the surrounding tissue before completely losing its energy. The damage to cell(s) along Auger electron's path is great, because the density of energy transfer per micrometer is much higher than regular electrons or photons, and would be similar to protons.

### EXAMPLE 4

Similar to Example 3 above, a platinum and depleted uranium anode will create fluorescent monochromatic beams consisting of 94-95 keV and 65 keV packets. This beam is useful for imaging where and when platinum-based chemotherapy drugs are aggregated and how the drug is distributed throughout a malignant area; combining platinum-based chemotherapy drug with Auger radiation as described in Example 3 above to achieve synergistic effects of tumor cell kill.

In all cases, a certain portion of L→K energy release in vivo will lead not to Auger electron emission, but fluorescent photon emission. These fluorescent photons can be detected using X-ray imaging devices or spectrometer devices, as commonly practiced in radiology and X-ray astronomy, which serve as a fingerprint of where enhanced radiation effects are taking place in vivo. Thus the methodology embodied in the present invention can also be used to achieve in vivo imaging and image-guided therapy. In this respect, in vivo imaging is similar to nuclear medicine imaging applications but without the need for radiopharmaceuticals; the image-guided therapy method is directly imaging where therapy is concurrently taking effect, i.e., serves as a direct verification of the location and magnitude of dose deposition.

### EXAMPLE 5

A variety of medical inventions have been tried for preventing restenosis at the site of stenting in coronary artery angioplasty or peripheral artery angioplasty. Radiation has been used prophylactically to reduce the chance of restenosis. However, radiation is difficult to deliver precisely while sparing adjacent critical organs (e.g., heart, lung) after stent placement, and therefore is commonly delivered during angioplasty catheterization via radioactive beads. With the methods and devices of the present invention, target the atomic number composition of the stent may be targeted to any desired radiation dose either immediately after angioplasty/stenting or any time afterwards to prevent restenosis. That is, a stent or scaffold that includes or is coated with a high Z element can be used to treat the cardiovascular disease. Preferred high Z elements for inclusion in the stent include gold or platinum. With a stent that includes at least one high Z element, doctors can use radiation with high rate of interaction with the high Z element to deposit sufficient dose locally to reduce and eliminate restenosis. Only blood vessels immediately adjacent to the stent will receive significant radiation, i.e., this methodology is “self-targeting” to the stent. There is currently no method to repeatedly treat re-occlusion of the stent (re-occlusion is a natural immune response of the body to the foreign object).

### EXAMPLE 6

The present methods can be used in cancer radiation therapy, especially in conjunction with high atomic number contrast injection such as iodine, gadolinium, gold nanoparticles, or in combination with other chemotherapy drug administration such as Cisplatin, Carboplatin, Bromodeoxyuridine, iododeoxyuridine. It is readily appreciated that this list is not meant to be exhaustive; instead, rapid proliferation of new generations of tumor-targeting nanoparticles, monoclonal antibodies, or any other future inventions can be tagged or may already contain a high atomic number moiety. The process and method of the present invention are readily adaptable to any such high atomic number compounds simply by using an anode of that atomic element and one sufficiently heavier element easily chosen based on the principles expounded in the present invention. It is especially well suited to ablation of tumor vasculatures, which would shut down the supply of nutrients and energy to the tumor or small metastasis.

### EXAMPLE 7

The present devices and methods can be useful with any diagnostic imaging that utilizes x-rays to decrease the dose administered to the patient. For example, with dental X-rays, the parotid gland, thyroid, facial tissue, tongue, oral cavity would all receive a lower dose of radiation. These soft tissue structures are prone to cancer development when exposed to X-rays ionizing radiation. The present invention by virtue of its monochromacity of X-rays permits excellent imaging at low exposures, because unlike broadband radiation, all photons are equally useful.

### EXAMPLE 8

Aspects of the invention are useful with dual energy X-ray absorptiometry for measuring bone mineral density for such diagnostic applications as detecting osteoporosis. Current commercial systems employ two sets of broadband X-rays at different kVp to achieve differential imaging of the higher atomic number minerals in the bone. The present invention uses two or more discrete energies, which can be suitably chosen to differentiate and quantify various mineral distributions. The methods and devices described here provide a novel method for conducting dual energy X-ray absorptiometry.

### EXAMPLE 9

Aspects of the invention are useful for mammography. Molybdenum or rhodium anodes are currently used in mammography X-ray machines, but not the simultaneous deployment of both elements in one image. Aspects of the present invention provide a plurality of anode elements and thus a plurality of discrete energies for achieving differential contrast of endogenous higher atomic number constituents in breast cancers which could prove extremely useful in breast cancer screening, as well as in screening for other types of cancers.

### EXAMPLE 10

Imaging and therapy using monochromatic x-rays is also highly advantageous in optimizing a radiation dose a priori. The interaction of single-energy x-rays with the body and radio sensitized tumor can be more easily modeled with numerical simulations than that of broadband radiation. Monte Carlo simulation codes such as the open software code GEANT4 can be employed to simulate and compute more precisely the administered dose to tumor cells as opposed to intervening healthy tissue.

1. An apparatus for converting a broadband x-ray beam to at least one substantially monochromatic x-ray beam comprising
a shielded housing having an inner cavity;
a fluorescent target disposed in the inner cavity wherein the fluorescent target emits at least one substantially monochromatic x-ray beam when exposed to a broadband x-ray beam;
a first opening in the housing configured to allow the broadband x-ray beam from an x-ray source to enter the inner cavity and irradiate the fluorescent target; and
a second opening in the housing configured to allow the at least one substantially monochromatic x-ray beam emitted by the fluorescent target to exit the housing.

2. The apparatus of claim 1 wherein the fluorescent target includes at least one high Z element.

3. The apparatus of claim 2 wherein the at least one high Z element has an atomic number of at least 20.

4. The apparatus of claim 2 wherein the at least one high Z element is selected from the group consisting of Zr, Cu, Au, Ag, Br, I, Pt, Mo, Kr, U, Gd, W, and combinations thereof.

5. The apparatus of claim 1 wherein the irradiated surface of the fluorescent target is substantially planar.

6. The apparatus of claim 1 wherein the relative angle between the fluorescent target and at least one of the first and second openings is adjustable.

7. The apparatus of claim 1 wherein the housing includes at least one structure configured for reversibly coupling the housing to an x-ray machine.

8. The apparatus of claim 1 wherein the at least one structure is selected from the group consisting of a magnet, a bracket, and a mechanical attachment capable of maintaining a fixed geometry between the fluorescent target and the x-ray machine.

9. The apparatus of claim 1 further including a beam-shaping structure configured to shape the narrower bandwidth x-ray beam.

10. The apparatus of claim 9 wherein the beam-shaping apparatus is at least one of a pair of jaws forming a rectangular beam, a set of iris shutters forming a polygonal shaped beam, and a set of leaves forming an irregularly shaped beam.

11. A source for at least one substantially monochromatic x-ray beam comprising:
a vacuum chamber;
an electron source in the vacuum chamber which radiates focused electrons in a direction to strike an anode and generate a broadband x-ray;
a fluorescent target in the vacuum chamber having a planar surface arranged in the path of the broadband x-ray wherein the planar surface has an angle relative to the path of the broadband x-ray in the range of about 30 degrees to about 60 degrees.

12. The source for at least one substantially monochromatic x-ray beam of claim 11 wherein the fluorescent target includes at least one high Z element.

13. The source for at least one substantially monochromatic x-ray beam of claim 12 wherein the at least one high Z element has an atomic number of at least 20.

14. The source for at least one substantially monochromatic x-ray beam of claim 12 wherein the at least one high Z element is selected from the group consisting of Zr, Cu, Au, Ag, Br, I, Pt, Mo, Kr, U, Gd, W, and combinations thereof.

15. The source for at least one substantially monochromatic x-ray beam of claim 11 wherein the planar surface has an angle relative to the path of the broadband x-ray of about 45 degrees.

16. A source for at least one substantially monochromatic x-ray beam comprising:
a vacuum chamber;
an electron source in the vacuum chamber which radiates focused electrons in a direction to strike an anode that includes at least a first and a second fluorescent-element, wherein the surface of the anode irradiated with electrons is planar and has an angle relative to the path of the electrons in the range of about 30 degrees to about 60 degrees.

17. The source for at least one substantially monochromatic x-ray beam of claim 16 wherein the first fluorescent element and the second fluorescent element are a first high Z element and a second high Z element.

18. The source for at least one substantially monochromatic x-ray beam of claim 17 wherein the first and second high Z element has an atomic number of at least 20.

19. The source for at least one substantially monochromatic x-ray beam of claim 17 wherein the at least one high Z element is selected from the group consisting of Zr, Cu, Au, Ag, Br, I, Pt, Mo, Kr, U, Gd, W, and combinations thereof.

20. The source for at least one substantially monochromatic x-ray beam of claim 16 wherein the planar surface has an angle relative to the path of the broadband x-ray of about 45 degrees.

21. The source for at least one substantially monochromatic x-ray beam of claim 16 further comprising a filter to remove contaminating broadband x-ray spectrum from the at least one substantially monochromatic x-ray beam.

22. A method of delivering locally concentrated radiation to a sample comprising:
introducing at least one high Z element to the tissue; and
simultaneously irradiating the high Z element in the sample with at least a first substantially monochromatic x-ray beam and a second substantially monochromatic x-ray beam, wherein the first substantially monochromatic x-ray beam has an energy sufficient to ionize the k-shell of the high Z element thereby allowing an electron from an outer shell to collapse to the k-shell and release an x-ray photon, and the second substantially monochromatic x-ray beam has an energy sufficient elevate an electron from the k-shell a vacancy in an outer shell thereby reionizing the k-shell and sustaining the local x-ray emission cycle.

23. The method of claim 22 wherein the at least one high Z element has an atomic number of at least 20.

24. The method of claim 22 wherein the at least one high Z element is selected from the group consisting of Zr, Cu, Au, Ag, Br, I, Pt, Mo, Kr, Gd, W, and combinations thereof.

25. The method of claim 22 wherein the high Z element is associated with at least one of medical device, a contrast agent, a nanoparticle, a chemotherapy agent, a radiotherapy agent, radiosensitizing molecular agents, and combinations thereof.

26. The method of claim 25 wherein the medical device is a vascular stent.

27. The method of claim 22 wherein the sample is a biological tissue.

28. The method of claim 27 wherein the tissue includes a benign tumor, a malignant tumor, a lesion, an infectious agent, a plaque, a cyst, a blood vessel and combinations thereof.

29. The method of claim 22 wherein the first substantially monochromatic x-ray beam and the second substantially monochromatic x-ray beam are emitted from at least one fluorescent target that includes a first high Z element and a second high Z element and that has been irradiated with a broadband x-ray beam.

30. The method of claim 22 wherein the first substantially monochromatic x-ray beam is emitted from a first fluorescent target that includes a first high Z element and the second substantially monochromatic x-ray beam is emitted from a second fluorescent target that includes a second high Z element wherein the first and the second fluorescent targets have been irradiated with a broadband x-ray beam.

31. A diagnostic method comprising:
producing a first substantially monochromatic x-ray beam and a second monochromatic x-ray beam;
irradiating a sample with the first substantially monochromatic x-ray beam and the second monochromatic x-ray beam; and
detecting the first substantially monochromatic x-ray beam and the second monochromatic x-ray beam that pass through the sample.

32. The diagnostic method of claim 31 further comprising computing an image from the detected first and second monochromatic x-ray beams.

33. The diagnostic method of claim 31 further comprising introducing at least one high Z element to the sample prior to irradiating the sample.

34. The diagnostic method of claim 31 further comprising detecting a fluorescent emission from the irradiated high Z element in the sample.

35. The diagnostic method of claim 31 wherein the first substantially monochromatic x-ray beam has an energy sufficient to ionize the k-shell of the high Z element thereby allowing an electron from an outer shell to collapse to the k-shell and release an x-ray photon, and the second substantially monochromatic x-ray beam has an energy sufficient elevate an electron from the k-shell a vacancy in an outer shell thereby reionizing the k-shell and sustaining the local x-ray emission cycle.

36. The diagnostic method of claim 33 wherein the at least one high Z element has an atomic number of at least 20.

37. The diagnostic method of claim 33 wherein the at least one high Z element is selected from the group consisting of Zr, Cu, Au, Ag, Br, I, Pt, Mo, Kr, Gd, W, and combinations thereof.
